(19) United States
(12) Patent Application Publication
(10) Pub. No.: US 2005/0005901 A1
(43) Pub. Date: Jan. 13, 2005

(54) Method for starting an internal combustion engine, in particular that of a motor vehicle

(76) Inventors: Andreas Kufferath, Markgroeningen (DE); Jochen Laubender, Stuttgart (DE); Andre-Francisco Casal Kulzer, Boeblingen (DE)

Correspondence Address: KENYON & KENYON, ONE BROADWAY, NEW YORK, NY, 10004, US

(21) Appl. No.: 10/848,484

(22) Filed: May 17, 2004

(30) Foreign Application Priority Data
May 16, 2003 (DE) 103 22 014.3

(51) Int. Cl. F02B 3/04

(52) U.S. Cl. 123/299

(57) ABSTRACT

A method for starting an internal combustion engine, in particular of a motor vehicle, is described. The internal combustion engine has a plurality of cylinders and a starter motor. The internal combustion engine is set in motion by the starter motor, and fuel is injected directly into a combustion chamber of the internal combustion engine where it is combusted. Fuel, in the form of at least two partial injections, is injected into the particular cylinder that executes a first compression stroke after a starting onset, starting from which the internal combustion engine is set in motion, the injection taking place during the compression stroke into the combustion chamber.

### FIELD OF THE INVENTION

The present invention relates to a method for starting an internal combustion engine, in particular that of a motor vehicle, the internal combustion engine having a plurality of cylinders and a starter motor, and the internal combustion engine being set in motion by the starter motor and fuel being injected directly into a combustion chamber of the internal combustion engine, where it is combusted. The present invention also relates to a computer program, a control device and an internal combustion engine of a corresponding type.

### BACKGROUND INFORMATION

A previously proposed method is known, for example, from internal combustion engines having direct injection in which the internal combustion engine is started in stratified operation. In starting an internal combustion engine it must generally be taken into account that this requires more fuel than normal operation of the same. This is due to the fact that a so-called wall film forms during the start of the internal combustion engine, in particular on the cylinder walls of the internal combustion engine. As a result, the fuel mass required for this purpose is unable to contribute to the combustion and thus to the starting of the internal combustion engine.

### SUMMARY OF THE INVENTION

It is an object of the present invention to provide a method for starting an internal combustion engine by which an improvement in the starting procedure may be achieved, in particular with respect to reducing emissions and the fuel consumption.

According to the present invention, this object is achieved in a method of the type mentioned in the introduction in that fuel in the form of at least two partial injections is injected into the combustion chamber during the compression stroke in the particular cylinder that executes a first compression stroke once the start has begun, starting from which the internal combustion engine is set in motion. In a computer program or a control device or an internal combustion engine of the type mentioned in the introduction, this object is achieved accordingly.

Due to the partial injections, a better homogenization of the stratified-charge cloud produced in the combustion chamber is attained. This results in better vaporization of the individual fuel droplets, so that, overall, more fuel is able to participate in the subsequent combustion. At the same time, the more effective vaporization of the fuel results in less fuel accumulating on the cylinder walls, in particular. Compared to normal stratified operation of the internal combustion engine during which the fuel is injected into the combustion chamber in the form of a single injection, the method according to the present invention thus achieves better utilization of the injected fuel. However, this also means that less fuel may be injected, that is, the fuel consumption is reduced during starting.

Due to the fact that the fuel is injected directly into the combustion chamber during the compression stroke, it is nevertheless ensured at the same time that an ignitable fuel/air mixture is produced in the combustion chamber despite the reduced fuel quantity, which leads to a reliable combustion and thus to a reliable starting of the internal combustion engine.

Furthermore, the method of the present invention reduces the emissions of the internal combustion engine, in particular the quantity of unburned hydrocarbons. The present invention also makes it possible for the exhaust system to have smaller dimensions. This is the result, in particular, of the reduced emissions during the starting of the internal combustion engine. As another measure, it is then possible to heat this exhaust system to its operating temperature more rapidly, for example by timing retardation.

Additional features, application possibilities and advantages of the present invention result from the following description of exemplary embodiments of the present invention, which are shown in the figures of the drawing. In this context, all of the described or represented features, by themselves or in any combination, form the subject matter of the present invention, as well as regardless of their formulation and representation in the specification and drawing, respectively.

### BRIEF DESCRIPTION OF THE DRAWINGS

FIG. 1 shows a schematic representation of an exemplary embodiment of an internal combustion engine according to the present invention.

FIG. 2 shows a schematic flow chart of an exemplary embodiment of a method according to the present invention for starting the internal combustion engine of FIG. 1.

### DETAILED DESCRIPTION

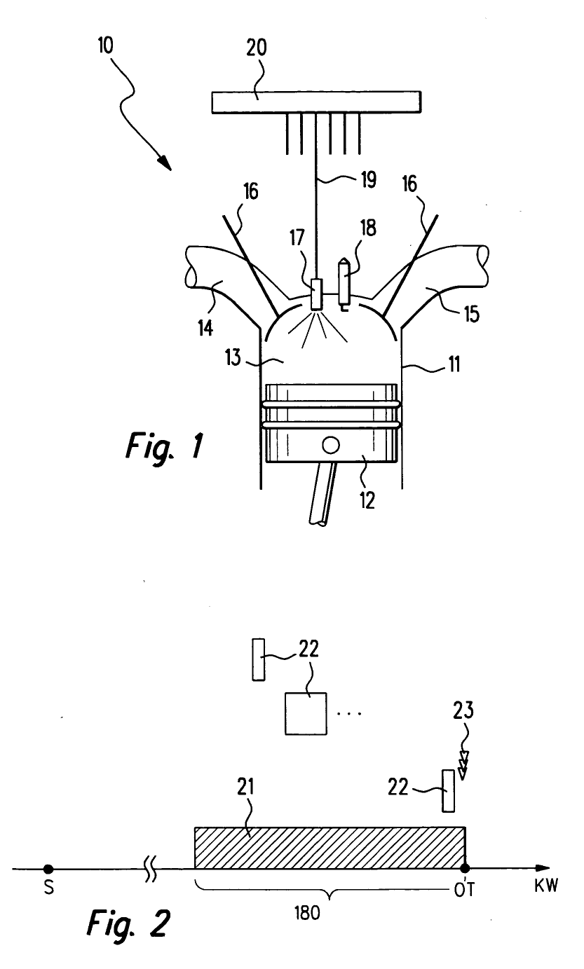

FIG. 1 shows an internal combustion engine 10, which is intended to be used in a motor vehicle, in particular. Internal combustion engine 10 is a gasoline internal combustion engine having direct injection. However, the invention described in the following may be used in a corresponding manner for a diesel combustion engine as well.

Internal combustion engine 10 has a plurality of cylinders, one of which, a cylinder 11, is shown in FIG. 1. A piston 12 may be moved back and forth inside cylinder 11. Cylinder 11 and piston 12 delimit a combustion chamber 13. Connected to combustion chamber 13 is an intake manifold 14, via which air may be conveyed to combustion chamber 13 el injector 17 is connected to a fuel accumulator 20 via a high-pressure line 19. Fuel accumulator 20 is continuously supplied with fuel under high pressure. For this purpose, a fuel-delivery pump and a high-pressure pump are normally provided. The pressure in fuel accumulator 20 may be controlled and/or regulated to specified values. To this end, a pressure sensor and a pressure-control valve may be assigned to fuel accumulator 20. All cylinders of internal combustion engine 10 are then supplied with fuel from pressure reservoir 20.

FIG. 2 shows a method for starting internal combustion chamber 10. This method is implemented by a control device that receives input signals from sensors, for example the pressure sensor, and generates the output signals for actuators, such as fuel injector 17 or the pressure-control valve, via which internal combustion engine 10 is able to be controlled. The control device is designed in such a way that it is able to execute the method described in the following. To this end, the control device may be designed as analog circuit technology and/or as digital processor having a memory. In the latter case, a computer program is provided, which is programmed such that the described method is implemented with the aid of the computer program.

In FIG. 2, the start phase of internal combustion engine 10 has been plotted over crankshaft angle KW, and thus indirectly also over time. This start phase begins with a starting onset S during which a starter motor begins to set internal combustion engine 10 in motion.

Subsequently, the starting phase has a first compression stroke 21, which is assigned to the particular cylinder of internal combustion engine 10 that is the first to execute its compression stroke following starting onset S. As is shown in FIG. 2, this compression stroke 21 extends across 180 degrees KW up to top dead center TDC of the particular cylinder.

In this first compression stroke 21, fuel is injected into the associated cylinder of internal combustion engine 10. This injection is implemented with the aid of fuel injector 17, directly into combustion chamber 13 of this cylinder. Due to the injection, a stratified charge cloud of fuel is produced in combustion chamber 13 in the region of spark plug 18.

As can be gathered from FIG. 2, the injection of the fuel is implemented in the form of a plurality of partial injections 22. These may be two or more partial injections 22. The time intervals of the individual partial injections 22 may differ or may also be identical with respect to each other. The particular duration of the individual partial injections may likewise be different or be identical as well. Any combinations are possible, too.

Because the fuel is injected in the form of several partial injections 22, a homogenization of the stratified-charge cloud in combustion chamber 13 is achieved. Air layers are produced between the individual injected fuel quantities of the individual partial injections 22, thereby supporting the vaporization of the fuel within the stratified-charge cloud. In this manner, a stratified-charge cloud is produced in the region of spark plug 18, in the form of a largely homogenous fuel/air mixture having a high fuel portion, which is present in the form of vapor.

This fuel/air mixture is ignited with the aid of spark plug 18 approximately in top dead center TDC of the associated cylinder. This is indicated by an ignition spark 23 in FIG. 2. In the present first compression stroke, the ignition more likely occurs shortly before top dead center TDC.

This results in a first combustion in internal combustion engine 10.

The second combustion occurs in the particular cylinder of internal combustion engine 10 that next executes its compression stroke. Partial injections 22 as well as ignition 23 are essentially implemented in the same manner as explained in connection with FIG. 2.

This essentially applies to the following additional combustions during the starting phase of internal combustion engine 10 as well.

It is possible here that during the start phase, in the course of the consecutively occurring combustions, the implemented partial injections 22 are modified, namely with respect to their number, their time intervals and/or their time durations. It is also possible to modify the individual ignitions 23 in the course of the consecutive combustions, in particular in the direction of an ignition instant after top dead center of the particular cylinder.

Another possibility is to modify the pressure acting on the fuel during the starting phase, such pressure ultimately being generated and maintained by fuel accumulator 20. Such a modification has an effect especially on the vaporization of the fuel inside combustion chamber 13 of internal combustion engine 10.

Additional modifications of the parameters influencing the consecutive combustions are possible when the speed of internal combustion engine 10 approaches idling speed. A slow transition may then be made to normal stratified-charge operation without partial injections, or to homogenous operation.

The described method for starting internal combustion engine 10 may be used at all operating temperatures, that is, in a cold start of internal combustion engine 10 as well.

1. A method for starting an internal combustion engine having a plurality of cylinders and a starter motor, comprising:
causing the starter motor to set the internal combustion engine in motion;
directly injecting a fuel into a combustion chamber of the internal combustion engine so as to cause a combusting of the fuel in the combustion chamber; and
injecting the fuel as at least two partial injections into a cylinder that executes a first compression stroke after a starting onset, starting from which the internal combustion engine is set in motion, the at least two partial injections taking place during the first compression stroke into the combustion chamber.

2. The method as recited in claim 1, wherein:
the internal combustion engine is that of a motor vehicle.

3. The method as recited in claim 1, wherein:
the at least two partial injections are injected consecutively at different time intervals.

4. The method as recited in claim 1, wherein:
the at least two partial injections have different time durations.

5. The method as recited in claim 1, further comprising:
in subsequent compression strokes, injecting the fuel as further partial injections.

6. The method as recited in claim 5, wherein:
time intervals of at least one of the at least two partial injections and the further partial injections change during consecutive compression strokes.

7. The method as recited in one of claims 5, wherein:
the time durations of at least one of the at least two partial injections and the further partial injections change during consecutive compression strokes.

8. The method as recited in claim 1, further comprising:
modifying a pressure acting on the fuel in consecutive compression strokes.

9. The method as recited in claim 1, further comprising:
igniting the injected fuel approximately at an end of the compression stroke corresponding approximately at top dead center of an associated one of the plurality of cylinders.

10. The method as recited in claim 9, further comprising:
shifting an ignition instant in consecutive compression strokes in a direction of after top dead center.

11. A computer program including instructions that when executed results in a performance of the following:
causing a starter motor of an internal combustion engine to set the internal combustion engine in motion;
directly injecting a fuel into a combustion chamber of the internal combustion engine so as to achieve a combusting of the fuel in the combustion chamber; and
injecting the fuel as at least two partial injections into a cylinder that executes a first compression stroke after a starting onset, starting from which the internal combustion engine is set in motion, the at least two partial injections taking place during the first compression stroke into the combustion chamber.

12. A control device programmed to cause a performance of the following:
causing a starter motor of an internal combustion engine to set the internal combustion engine in motion;
directly injecting a fuel into a combustion chamber of the internal combustion engine so as to achieve a combustwafer is prepared to have a support wafer made of silicon, a carrier passivation layer formed on a surface of the support wafer, a membrane formed on the carrier passivation layer, and a plurality of posts on the membrane. The carrier passivation layer is inert to a gaseous etchant that etches silicon. The carrier wafer is placed on a device wafer to bond the posts to the device wafer. A passivation layer is then formed on exterior surfaces of the device wafer while leaving the support wafer exposed. The bonded carrier wafer and the device wafer are exposed to the gaseous etchant to etch away the support wafer in the carrier wafer and to expose the carrier passivation layer. Next, the carrier passivation layer is removed to transfer the membrane to the device wafer.

13. An internal combustion engine, comprising:
a starter motor;
a plurality of cylinders; and
a control device programmed to cause a performance of the following:
causing the starter motor to set the internal combustion engine in motion,
directly injecting a fuel into a combustion chamber of the internal combusion engine so as to achieve a combusting of the fuel in the combustion chamber; and
injecting the fuel as at least two partial injections into a cylinder that executes a first compression stroke after a starting onset, starting from which the internal combustion engine is set in motion, the at least two partial injections taking place during the first compression stroke into the combustion chamber.
